(19) United States
(12) Patent Application Publication
(10) Pub. No.: US 2020/0110520 A1
(43) Pub. Date: Apr. 9, 2020

(54) Displaying Pop-Up Overlays at Selected Time Points on an Electronic Page

(71) Applicant: Pulsemotiv, LLC, South Jordan, UT (US)

(72) Inventors: Eslee Buckley Barlow, Bluffdale, UT (US); Steven Blake Kiger, Draper, UT (US)

(21) Appl. No.: 16/153,492

(22) Filed: Oct. 5, 2018

(51) Int. Cl. G06F 3/0483; G06F 3/16; G06F 3/0482; G06F 15/18

(52) U.S. Cl. CPC G06F 3/0483; G06F 15/18; G06F 3/0482; G06F 3/165

(57) ABSTRACT

Technology is described for engaging a user while accessing an electronic page. An event may be received via a user interface control in the electronic page to initiate playback of audio data. The audio data may be played using an audio player associated with an electronic page as initiated by the event. A defined time may be determined as being reached in the audio data. A trigger event associated with the defined time in the audio data may be identified. A pop-up overlay may be displayed in response to the trigger event identified for the defined time in the audio data. The pop-up overlay may include a user interface control to capture a user action in response to the pop-up overlay being presented.

### BACKGROUND

With millions of active websites on the World Wide Web today, maintaining visibility and user interest in a website may be challenging. Users often desire an exceptional experience (e.g., interesting and engaging content, low latency when loading an electronic page, links that work correctly, etc.) when visiting a website. When the user experience for a particular website is lacking, due to the large number of alternative websites that offer products, services, or information, users may simply visit another website that provides an improved user experience.

Another challenge is the ability to expose users to a particular website. Search engines often provide links to the most relevant and useful websites, and with the large number of websites on the World Wide Web, it can be challenging for a particular website to rank highly on a listing of search results. Search engine optimization (SEO) may involve optimizing words or features in a website that cause the website to rank higher on the listing of search results, in order to improve user traffic for the website. Search engines may use a large number of factors to determine which websites are the most useful and relevant, which may include an amount of time spent on a particular website, keyword metadata for the website, a speed of the website, a number of inbound links for the website, a quality of the inbound links for the website, etc.

### BRIEF DESCRIPTION OF THE DRAWINGS

FIG. 1 illustrates an electronic page that includes an audio player for playing audio according to an example of the present technology.

FIG. 2 illustrates an electronic page that plays audio via an audio player and displays pop-up overlays at defined time points in the audio according to an example of the present technology.

FIG. 3 illustrates a system and related operations for hosting an electronic page at a web server that receives audio data and other media from a server computer or pop-up overlay delivery service and is accessible to a client device according to an example of the present technology.

FIG. 4 illustrates a user interface for identifying audio data, selecting time points in the audio data and creating pop-up overlays that correspond to the time points according to an example of the present technology.

FIG. 5 is a flowchart of an example method for engaging a user while accessing an electronic page.

FIG. 6 is a flowchart of another example method for engaging a user while accessing an electronic page.

FIG. 7 is a flowchart of yet another example method for engaging a user accessing an electronic page.

FIG. 8 is a block diagram of a service provider environment according to an example of the present technology.

FIG. 9 is a block diagram that provides an example illustration of a computing device that may be employed in the present technology.

### DETAILED DESCRIPTION

A technology is described for engaging a user while accessing an electronic page. The electronic page may be contained in a browser (e.g., a website) or an application. The electronic page may be accessed by the user using a computing device, such as a desktop computer, laptop, mobile device, tablet computer, etc. For example, the computing device may run the browser that accesses the electronic page or the computing device may execute the application that accesses the electronic page. The electronic page may include a media player (e.g., an audio player) configured to play audio data, video data and/or animation data. The electronic page may include electronic page content related to the audio data and other media data (e.g., video, images, and animations). The audio data may have defined time points in the audio data. When the audio data that is playing reaches one of the defined time points, a pop-up overlay may be displayed on the electronic page. The pop-up overlay may include text, electronic links, digital media (e.g., audio, video, images, animations, etc.) that enables the user to engage with or perform a user action with the pop-up overlay.

In one configuration, an event may be received via a user interface control in the electronic page to initiate playback of audio data. For example, the event received via the user interface control may involve a user selecting an option on the user interface control to initiate playback of the audio data. The audio data may be played using the audio player associated with the electronic page (e.g., the audio player may be embedded in the electronic page or loaded into the electronic page), as initiated by the event. Alternatively, playback of the audio data may be initiated automatically when the electronic page is loaded or when a cursor moves in a certain pattern on the electronic page. The audio player may include options to play the audio data, pause the audio data, fast forward or rewind the audio data (e.g., 2× or 3×), etc. The electronic page may include a progress play bar for the audio data that is shaped in a curvi-linear line, a line or another shape, and a graphical indicator displays progress in the playback of the audio data in the curvi-linear line. Alternatively, the electronic page may include a progress play bar for the audio data that is shaped in a sinusoidal path.

In one configuration, the audio data may have one or more time points marked within the audio data. As the audio player on the electronic page plays the audio data, a defined time point may be reached in the audio data. A desired trigger event associated with the defined time point in the audio data may be identified. As non-limiting examples, the trigger event associated with the defined time point in the audio data may be presented with the opportunity for purchasing a product or service, obtaining a membership for a website, or providing additional information to a user which is related to the audio data. The pop-up overlay may be displayed based on the trigger event identified for the defined time in the audio data. The pop-up overlay may include a graphical user interface control to capture a user action in response to the pop-up overlay being presented. In one example, the pop-up overlay may be a slide out user interface control that overlays the electronic page. In another example, the pop-up overlay may be a user interface control that overlays the electronic page and presents an action a user selects.

In one example, the trigger event associated with the defined time point may be used or checked in combination with another trigger event, such as a user action (or non-action) that is performed on the electronic page. Examples of such user actions may include moving a cursor towards an exit button, putting a cursor near a buy button, or when there is no user activity for a defined period of time. As an example, the trigger event(s) of hovering a cursor at a certain position on the electronic page in combination with the defined time point reached in the audio data may cause the pop-up overlay to be displayed.

In one example, the audio player may include an embedded pop-up triggering tool or may interface with an external pop-up triggering tool, and the pop-up triggering tool may be responsible for identifying an occurrence of the trigger event and initiating the display of the pop-up overlay based on the occurrence of the trigger event. The pop-up triggering tool may function to drive the display of the pop-up overlay when one or more trigger events occur (e.g., when the defined time point is reached and/or based on user actions (or non-actions) that are performed on the electronic page.

In one configuration, a user action may be received in the pop-up overlay. For example, the user action may involve a user clicking on an electronic link, clicking a purchase button, clicking a join button, answering a question or completing a survey, viewing a video, etc. Additional action material may be displayed in the electronic page or in a second electronic page in response to the user action.

In one example, the audio data that includes a person's voice may be used in combination with the pop-up overlays that are configured to be displayed at the defined time points to create an engaging experience for the user accessing the electronic page. The pop-up overlays may enable the user to perform various user actions, thereby increasing the user's interaction and presumably engagement with the electronic page. As a result, the user may be more likely to spend an increased amount of time engaging with the electronic page and may be more likely to perform the various user actions (e.g., purchase a product, sign up for a service). In addition, since users may spend an increased amount of time engaging with the electronic page, the electronic page may be ranked higher when users perform searches using a search engine. In other words, the electronic page may be displayed more prominently in search results because the search engine may consider the electronic page as having increased relevance due to user engagement with the electronic page content.

As a non-limiting example, a user may be visiting an electronic page that provides camping equipment for sale. The electronic page may include an audio player, which enables the user to listen to an audio recording of an expert in camping equipment. The audio recording may briefly describe the pros and cons for a number of camping tents, and at a beginning of each segment pertaining to a particular camping tent, a pop-up overlay may be displayed that includes information, an electronic link to purchase, an instructional video, etc. for that particular camping tent. As a result, the user may be more likely to have an engaging experience when visiting the electronic page that provides camping equipment for sale.

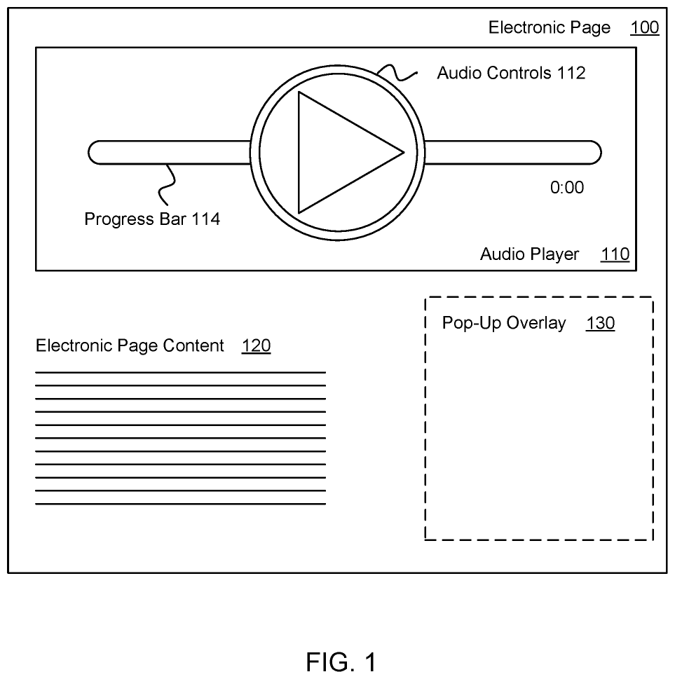

FIG. 1 illustrates an example of an electronic page 100 that includes an audio player 110 for playing audio. The electronic page 100 may be displayed on a display screen of a computing device that is running a browser or executing an application. As non-limiting examples, the electronic page 100 may be associated with retail goods, software products, services, a personal website, a social networking website or application, a photo sharing website or application, a blog, an informational website or application, a directory, an e-commerce website or application, etc. The electronic page 100 may include the audio player 110, which may include audio controls 112 (e.g., play, pause, stop, fast forward, rewind), as well as a progress bar 114 that indicates a time position within an audio file. The electronic page 100 may include electronic page content 120, which may include text, figures, animations, etc.

In one example, the audio controls 112 may be animated to capture the user's attention. For example, the audio controls 112 may include a play control that is pulsating or expanding/contracting in an animated manner to capture the user's attention. As a result, the user may be more likely to be attracted to the electronic page 100 and may be more likely to listen to audio on the electronic page 100 via the audio player 110. In another example, the electronic page 100 may include scrolling text, flashing text, animations, brief video images, etc. that prompt the user to start listening to the audio file via the audio player 110.

In the example shown in FIG. 1, the audio player 110 may indicate that a particular audio file has not begun playing (e.g., a current time code for the audio may be 0:00). Therefore, in this example, the electronic page 100 may not include a pop-up overlay 130 at this point in time. As explained in further detail below, the pop-up overlay 130 may appear on the electronic page 100 after a particular time point has been reached in the audio file.

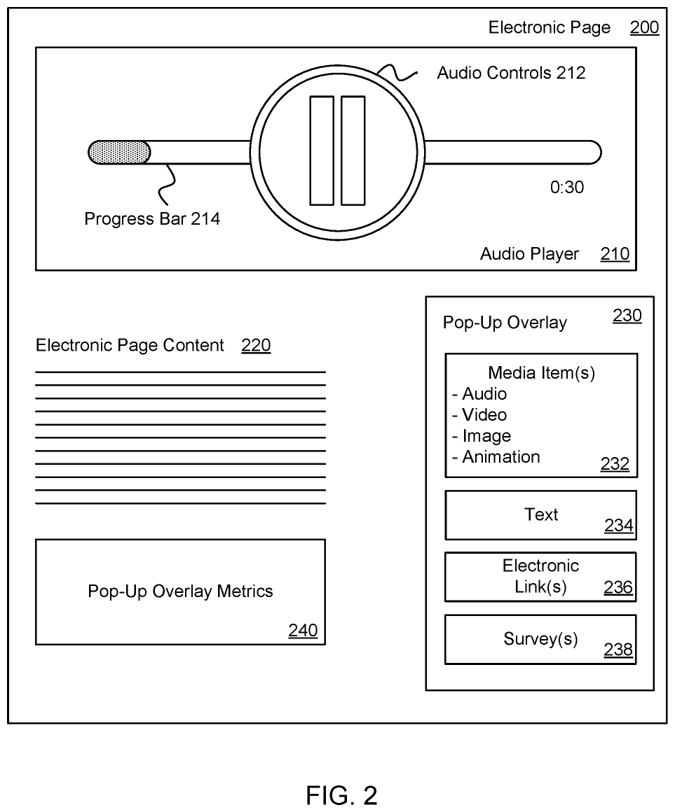

FIG. 2 illustrates an example of an electronic page 200 that plays audio via an audio player 210 and displays a pop-up overlay 230 at a predefined time point in an audio file. The electronic page 200 may include the audio player 210, which may include audio controls 212 and a progress bar 214. The electronic page 200 may include electronic page content 220. In this example, the audio player 210 may indicate that a particular audio file is playing (e.g., a current time code for the audio may be 0:30). In this example, a certain time point may be reached in the audio file, and when the time point is reached, the electronic page 200 may display the pop-up overlay 230. In other words, the pop-up overlay 230 may initially not be displayed on the electronic page 200 when the audio file is being played, but may be displayed upon a predefined time point (e.g., 0:30) being reached during playback of the audio file. The display of the pop-up overlay 230 may be triggered based on the predefined time point being reached. The pop-up overlay 230 may be a slide out user interface control that overlays the electronic page 200 and slides out from an edge of a browser or application. The pop-up overlay 230 may enable the user consuming the electronic page 200 to perform various user actions, such as interacting with media item(s) 232 (e.g., video, audio, images, animations) included in the pop-up overlay 230, viewing text 234 included in the pop-up overlay 230, selecting electronic link(s) 236 (e.g., an electronic link to a product page) included in the pop-up overlay 230, clicking buttons on a survey 238 included in the pop-up overlay 230, etc.

In an alternative example, the display of the pop-up overlay 230 may be triggered based on user actions that are performed with respect to the electronic page 200. For example, the display of the pop-up overlay 230 may be triggered when the user moves a cursor towards an exit button, which may serve to prolong the user's interest in the electronic page 200. The display of the pop-up overlay 230 may be triggered when there is no user activity for a defined period of time, which may also serve to stimulate the user's interest in the electronic page 200. In another example, display of the pop-up overlay 230 may be triggered when the user is listening to an audio file and moves a cursor over a purchase button on the electronic page 200, but no selection of the purchase button is made.

In one example, the pop-up overlay 230 that includes the media item(s) 232, text 234, electronic link(s) 236, survey(s) 238, etc. may serve to increase the user's engagement and presumably interest with the electronic page 200. As a result, the user may be more likely to spend an increased amount of time engaging with the electronic page 200 and may be more likely to perform various user actions (e.g., purchase a product, sign up for a service) based on the pop-up overlay 230. In addition, since the user may spend an increased amount of time engaging with the electronic page 200, then the electronic page 200 may be ranked higher when users perform searches using a search engine. In other words, the electronic page 200 may be displayed more prominently in search results because the search engine may consider the electronic page 200 as having increased relevance based on user engagement with an electronic page.

In one example, the audio player 210 on the electronic page 200 may continue playing the audio file after the pop-up overlay 230 is displayed on the electronic page 200 at the predefined time point. As a result, the user may continue listening to the audio in the background when performing a user action via the pop-up overlay 230. Alternatively, the audio playing via the audio player 210 may be paused, which may enable the user to perform the user action via the pop-up overlay 230.

In one example, the pop-up overlay 230 may continue to be displayed on the electronic page 200 for a duration of time. For example, the pop-up overlay 230 may continue to be displayed on the electronic page 200 until a user action is performed with respect to the pop-up overlay 230 (e.g., clicking on an electronic link, answering a question or completing a survey, listening to an audio file, viewing a live video stream, etc.) In another example, the pop-up overlay 230 may continue to be displayed on the electronic page 200 until a subsequent time point in the audio file is reached, at which point a different pop-up overlay may be displayed on the electronic page 200. In yet another example, the pop-up overlay 230 may be displayed on the electronic page 200 for a predefined amount of time in accordance with a timer, and after expiry of the timer, the pop-up overlay 230 may be closed. In another example, the pop-up overlay 230 may be displayed on the electronic page 200 until a cursor performs a certain action on the electronic page 200, such as moving across another item on the electronic page 200.

In one example, the electronic page 200 may be associated with pop-up overlay metrics 240. The pop-up overlay metrics 240 may be included on the electronic page 200, or alternatively, the pop-up overlay metrics 240 may be included on a separate protected electronic page that is accessible to an administrator of the electronic page 200. The pop-up overlay metrics 240 may include metric data that is collected from a group of users for the pop-up overlay 230. The pop-up overlay metrics 240 may include a number of views for the pop-up overlay 230. The pop-up overlay metrics 240 may include a number of clicks for the pop-up overlay 230 (and a percentage of users that click on the for the pop-up overlay 230). The pop-up overlay metrics 240 may include a score for the pop-up overlay 230, which may represent a likelihood that a user performs a user action in response to viewing the pop-up overlay 230. In addition, the pop-up overlay metrics 240 may include an amount of time the group of users listen to the audio data on the electronic page 200 and whether users from the group of users perform user actions in response to the display of the pop-up overlay 230 on the electronic page 200. Therefore, the administrator that configures the electronic page 200 may gain knowledge about the electronic page 200 and a level of effectiveness for the pop-up overlay 230 on the electronic page 200.

In one example, the electronic page 200 may be applicable in a live chat setting and/or a knowledge-based setting. For example, users may ask questions using live chat software. The electronic page 200 may provide answers to the questions with audio, and the audio may be provided in combination with pop-up overlays 230 at predefined times in the audio. In another example, users may audibly listen to frequently asked questions (FAQs) and/or responses to FAQs in response to a knowledge-based search, and the electronic page 200 may provide audio in combination with the pop-up overlays 230.

In another example, the electronic page 200 may be accessible in an intranet setting or accessible publicly via the world wide web. For example, the electronic page 200 may provide an audio lecture or question to employees in a company, and the audio lecture or question may be provided in combination with pop-up overlays 230 at predefined times in the audio lecture. In this example, the pop-up overlays 230 may include surveys that are to be completed by the employees, and the pop-up overlays 230 with the surveys may serve to fully engage the employees that are listening to the audio lecture. In addition, when the electronic page 200 provides the audio lecture or question along with the pop-up overlays 230 to the employees in the company, an executive of the company may be able to determine whether employees (and specific employees) interacted with the pop-up overlays 230 displayed on the electronic page 200.

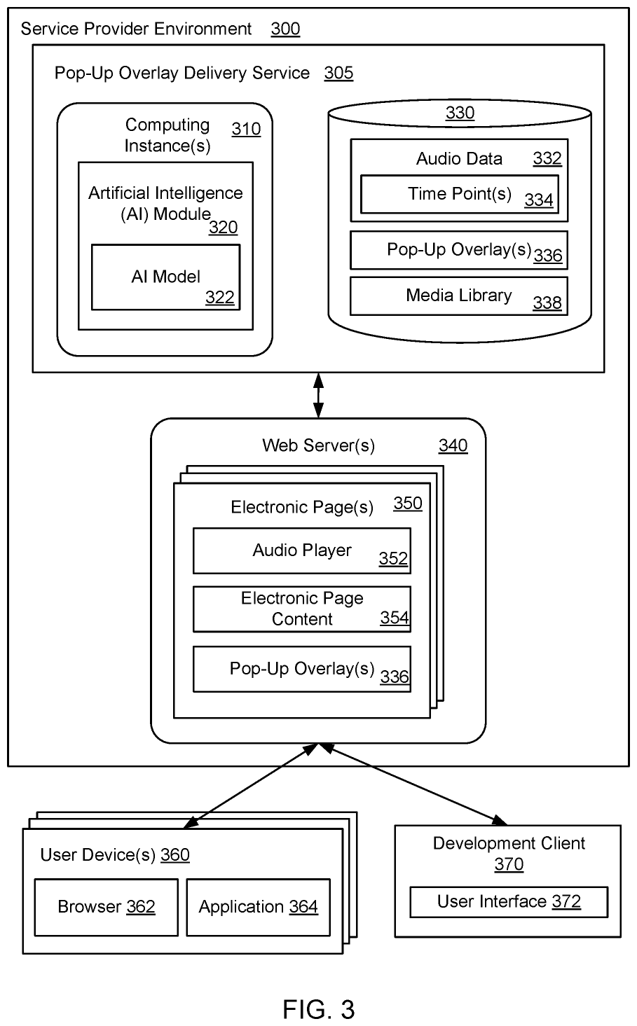

FIG. 3 illustrates an exemplary system and related operations for hosting electronic page(s) 350 at a web server 340 that receives audio data 332 from a pop-up overlay delivery service 305 that operates on one or more computing instances 310 in a service provider environment 300, and the electronic page(s) 350 may be accessible to a user device 360. Alternatively, the audio data 332 and pop-up overlays 336 may be obtained from a server in a local network and any other functions described for the pop-up overlay delivery service 305 below might also be hosted in a local server configuration. The user device 360 may run a browser 362 or execute an application 364 that accesses the electronic page 350 hosted at the web server 340. The electronic page 350 hosted by the web server 340 may include an audio player 352 and electronic page content 354. For example, the audio player 352 may be embedded in the electronic page 350. The audio player 352 may receive the audio data 332 from the pop-up overlay delivery service 305. In other words, the audio data 332 may be provided from the pop-up overlay delivery service 305 to the web server 340 for playback via the audio player 352 on the electronic page 350. The audio data 332 may be played via the audio player 352 on the electronic page 350. The audio data 332 may have various marked time points 334, which may be stored in a data store 330 of the pop-up overlay delivery service 305. When the audio player 352 that is playing the audio data 332 reaches one of the time points 334, the electronic page 350 may display pop-up overlay(s) 336. The pop-up overlay 336 may be stored in the data store 330 of the pop-up overlay delivery service 305. The pop-up overlay 336 may be provided from the pop-up overlay delivery service 305 to the web server 340 for display on the electronic page 350 when the time point 334 in the audio data 332 has been reached.

In one configuration, a development client 370 may include a user interface 372 that enables an administrator to configure the electronic page 350 to display the pop-up overlays 336 at the time points 334 in the audio data 332. The administrator may be an owner or operator of the electronic page 350, and the electronic page 350 may be configured to display the pop-up overlays 336 for users that visit the electronic page 350 using the user device(s) 360. In one example, the user interface 372 may be used to upload audio data 332 to the pop-up overlay delivery service 305. The development client 370 may capture or record the audio data 332 via a microphone at the development client 370. The audio data 332 may be a recording of the administrator's voice. Alternatively, the user interface 372 may be used to identify audio data 332 that is stored at the pop-up overlay delivery service 305. For example, a plurality of audio files may have been previously uploaded to the pop-up overlay delivery service 305, and the administrator may select or identify one of the audio files via the user interface 372 on the development client 370.

In one example, after the audio data 332 is selected, the administrator may identify the time point(s) 334 that are to be associated with the audio data 332 via the user interface 372 on the development client 370. In this example, the time point(s) 334 may be manually input or selected for the audio data 332 via the user interface 372 on the development client 370. The time point(s) 334 may correspond to a trigger event in the audio data 332, such as the purchasing of a product or service, obtaining a membership for a website, etc. After the time point(s) 334 are selected, the administrator may create the pop-up overlay(s) 336 to be displayed on the electronic page 350 at the time point(s) 334 in the audio data 332 via the user interface 372 on the development client 370. For example, the administrator may select media items (e.g., text, audio, video, animations, etc.) from a media library 338 stored at the pop-up overlay delivery service 305, and the media items may be incorporated into the pop-up overlay(s) 336. The pop-up overlay(s) 336 that are created via the user interface 372 on the development client 370 may be stored at the pop-up overlay delivery service 305, and the pop-up overlays 336 may be provided from the pop-up overlay delivery service 305 to the electronic page 350 hosted on the web server 340 when the audio data 332 has reached one of the time points 334.

As a non-limiting example, an administrator may operate an electronic page 350 related to a landscaping service. The administrator may create an audio recording using the development client 370. The administrator may upload the audio recording to the pop-up overlay delivery service 305 via the user interface 372 on the development client 370. Alternatively, the administrator may upload a text file to the pop-up overlay delivery service 305 via the user interface 372 on the development client 370, and the text file may be converted to audio (e.g., an audio recording or audio stream) using a text-to-speech tool. The administrator may select various time points 334 in the audio recording via the user interface 372 on the development client 370. For example, the user may select time points at 0:23 and 3:54 in the audio recording via the user interface 372 on the development client 370. Then, the administrator may create a first pop-up overlay for a first time point at 0:23 and a second pop-up overlay for a second time point at 3:54 via the user interface 372 on the development client 370. For example, the administrator may select various media items from the media library 338 for inclusion in the first and second pop-up overlays. The audio recording and the two pop-up overlays may be stored at the pop-up overlay delivery service 305. In addition, the administrator may configure the electronic page 350 that is hosted on the web server 340 to include the audio player 352 and retrieve the audio recording from the pop-up overlay delivery service 305 for playback via the audio player 352 on the electronic page 350. For example, the electronic page 350 may include embedded code to display the audio player 352 and retrieve the audio recording from the pop-up overlay delivery service 305 when the electronic page 350 is loaded on the user device 360. Furthermore, the web server 340 may be configured to retrieve the first and second pop-up overlays from the pop-up overlay delivery service 305, and the electronic page 350 may be configured to display the first and second pop-up overlays at the first and second time points of 0:23 and 3:54, respectively. As a result, when users visit the electronic page 350 using the user device(s) 360, the users may be exposed to the first and second pop-up overlays at the first and second time points of 0:23 and 3:54, respectively.

In one example, the pop-up overlay delivery service 305 may include multiple micro services that are used to perform the functionalities described above. For example, a first micro service may be used to receive the audio data 332, a second micro service may be used to identify the time points 334 in the audio data 332, and a third micro service may be used to generate and provide the pop-up overlays 336 to the electronic page 350.

In one example, the data store 330 in the pop-up overlay delivery service 305 may include the audio data 332. The audio data 332 may include audio files that are uploaded from the development client 370. The audio data 332 may include audio recordings from an administrator associated with the development client 370. The audio data 332 may include audio recording related to various products or services. Alternatively, the audio data 332 may include informational audio recording.

In one example, the data store 330 in the pop-up overlay delivery service 305 may include the time point(s) 334. The time points 334 may be associated with various time codes in the audio data 332. For example, a particular audio file in the audio data 332 may be associated with one or more time points 334. The time points 334 may correspond to particular actions events in the audio data 322, which may be related to the purchase of a product or service or obtaining a membership for a website, and the trigger event may result in providing additional information to a user which is related to the audio data 322.

In one example, the data store 330 in the pop-up overlay delivery service 305 may include the pop-up overlay(s) 336. The pop-up overlays 336 may be a slide out user interface control that overlays the electronic page 350. The pop-up overlays 336 may provide triggered content delivery at certain time points 334 in the audio data 332. The pop-up overlays 336 may enable the user consuming the electronic page 350 to perform various user actions, such as interacting with media item(s) (e.g., video, audio, animations) included in the pop-up overlay 336, viewing text included in the pop-up overlay 336, selecting electronic link(s) included in the pop-up overlay 336, etc.

In one example, the data store 330 in the pop-up overlay delivery service 305 may include the media library 338. The media library 338 may include media item(s) (e.g., video, audio, animations) for potential inclusion in the pop-up overlays 336. In other words, the media library 338 may be accessed when the pop-up overlays 336 are being created or loaded by devices 360.

The pop-up overlay delivery service 305 operating on the one or more computing instances 310 may include a number of modules for generating the time points 334 and/or the pop-up overlays 336. The pop-up overlay delivery service 305 may include an artificial intelligence (AI) module 320, and other applications, services, processes, systems, engines, or functionality.

The AI module 320 may obtain user profile data that is known about a group of users. The user profile data may include non-personally identifiable information about the users, such as a user location, a user demographic, or user interests. The AI module 320 may train an AI model 322 (or a machine learning model) using features of users identified from the user profile data. For example, the AI model 322 may be trained using features related to user locations, user demographics, user interests, etc. When a user accesses the electronic page 350, the AI module 320 may generate a pop-up overlay 336 to be displayed at an identified time point of the audio data 332 based on the user's profile features, purchase history, browsing history, user interests, targeted advertisements previously shown to the user, etc., as processed by the AI model 322. For example, the AI module 320 may select a particular combination of media items from the media library 338, electronic links, etc. for the pop-up overlay 336 that are known to be effective or high performing based on learned or predictive analytics, using the AI model 322. In other words, the pop-up overlay 336 may be selected to include a combination of audio, video, electronic links, text, animation, etc. based on the user's profile features as processed by the AI model 322, and the AI module 320 may provide the pop-up overlay 336 for display on the electronic page. As a result, the user may view pop-up overlays 336 with targeted content delivery that is specific to the unique characteristics of the user, and the AI module 320 may automatically generate the pop-up overlays 336 with minimal intervention from the administrator. In addition, the AI module 320 may be used to understand the user's intent when listening to the audio data 332, and the AI module 320 may select certain pop-up overlays 336 for display that are aligned with the user's intent, which may be distinct from selecting pop-up overlays 336 for predictive content delivery.

In another example, the AI module 320 may identify audio data 332 that is stored at the pop-up overlay delivery service 305. The AI module 320 may perform a speech-to-text analysis of the audio data 332 and identify one or more time points 334 in the audio data 332 that are of potential interest, using the AI model 322. The AI module 320 may identify certain words, phrases, a level of enthusiasm or intensity in tone, etc. to identify the one or more time points 334 in the audio data 332 that are of potential interest. The AI module 320 may provide a listing of time points that are of potential interest to the development client 370, and the administrator may accept or reject certain time points as being of interest or not of interest via the user interface 372 on the development client 370. Thus, the AI module 320 may determine the time points 334 in the audio data 332 with minimal intervention from the administrator.

In one example, the AI module 320 may further refine and improve the AI model 322 over time using various types of testing, such as AB testing or multivariate testing. As a result, the AI module 320 may identify pop-up overlays 336 that provide a positive user experience and result in an increased likelihood that the user performs certain actions (e.g., purchasing items, signing up for services) based on viewing the pop-up overlays 336.

The user device 360 may comprise a computer system that is embodied in the form of a desktop computer, a laptop computer, mobile devices, cellular telephones, smartphones, network-enabled televisions, tablet computer systems, or other devices with like capability.

The various processes and/or other functionality contained within the service provider environment 300 may be executed on one or more processors that are in communication with one or more memory modules. The service provider environment 300 may include a number of computing devices that are arranged, for example, in one or more server banks or computer banks or other arrangements. The computing devices may support a computing environment using hypervisors, virtual machine managers (VMMs) and other virtualization software.

The term “data store” may refer to any device or combination of devices capable of storing, accessing, organizing and/or retrieving data, which may include any combination and number of data servers, relational databases, object oriented databases, cluster storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

The pop-up overlay delivery service 305, the web server 340, the user device 360 and the development client 370 may communicate via a network. The network may include any useful computing network, including an intranet, the Internet, a localized network, a wide area network, a wireless data network, or any other such network or combination thereof. Components utilized for such a system may depend at least in part upon the type of network and/or environment selected. Communication over the network may be enabled by wired or wireless connections and combinations thereof.

FIG. 3 illustrates that certain processing modules may be discussed in connection with this technology and these processing modules may be implemented as computing services. In one example configuration, a module may be considered a service with one or more processes executing on a server or other computer hardware. Such services may be centrally hosted functionality or a service application that may receive requests and provide output to other services or consumer devices. For example, modules providing services may be considered on-demand computing that are hosted in a server, virtualized service environment, grid or cluster computing system. One or more API(s) may be provided for each module to enable a second module to send requests to and receive output from the first module. Such APIs may also allow third parties to interface with the module and make requests and receive output from the modules. While FIG. 3 illustrates an example of a system that may implement the techniques above, many other similar or different environments are possible. The example environments discussed and illustrated above are merely representative and not limiting.

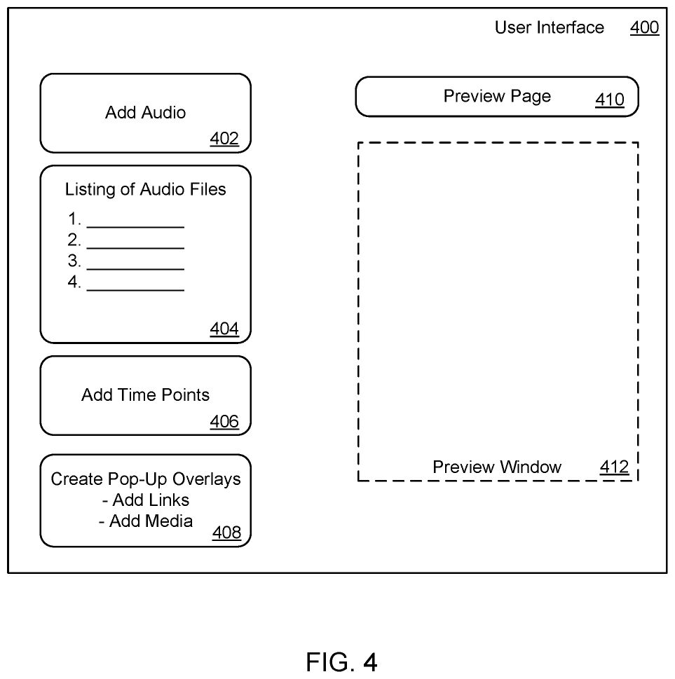

FIG. 4 illustrates an example of a user interface 400 for identifying audio data, selecting time points in the audio data and creating pop-up overlays that correspond to the time points. The user interface 400 may connect to a backend system in a service provider environment (as shown in FIG. 2) that is responsible for receiving the audio data, identifying the time points in the audio data and generating the pop-up overlays that correspond to the time points. The user interface 400 may be part of a development client (as shown in FIG. 3). The user interface 400 may include an ‘add audio’ control 402 for selecting or uploading an audio file. The audio files that are selected or uploaded may be displayed on a listing of audio files 404. The audio files may be organized in folders, which may be displayed on the listing of audio files 404. The user interface 400 may include an ‘add time points’ control 406 for adding time points to the audio files listed on the listing of audio files 404. The time points may be manually selected for each audio file via the user interface 400. The user interface 400 may include a ‘create pop-up overlays’ control 408 to create or design the pop-up overlays. For example, electronic links, media content, etc. may be incorporated into a particular pop-up overlay using the user interface 400. A position of the pop-up overlay (e.g., bottom left of screen, top right of screen) may be selected using the user interface 400. In addition, the user interface 400 may include a ‘preview page’ control 410 to preview the created pop-up overlays on a preview window 412 that is shown in the user interface 400. As a result, the user interface 400 enables an administrator to identify audio data, select time points in the audio data, design pop-up overlays that correspond to the time points, and preview and modify the pop-up overlays accordingly.

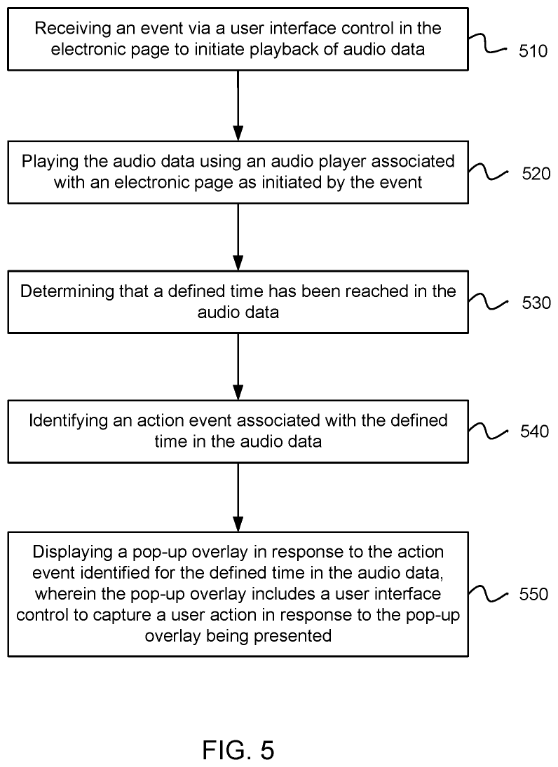

FIG. 5 illustrates an example of a method for engaging a user while accessing an electronic page. The electronic page may be contained in a browser or an application. An event may be received via a user interface control in the electronic page to initiate playback of audio data, as in block 510. For example, the event received via the user interface control may involve a user selecting an option on the user interface control to initiate playback of the audio data.

The audio data may be played using an audio player associated with an electronic page as initiated by the event, as in block 520. In one example, the audio player may be embedded in the electronic page. The audio player may include options to play the audio data, pause the audio data, fast forward or rewind the audio data, etc.

A defined time may be determined as being reached in the audio data, as in block 530. The audio data may be associated with one or more time points within the audio data. As an example, if the audio data is a one minute audio file, the time points may be predefined within the one minute audio file.

A trigger event associated with the defined time in the audio data may be identified, as in block 540. As an example, the trigger event may be the purchase of a product or service. As another example, the trigger event may be obtaining a membership for a website. As yet another example, the trigger event may result in providing additional information to a user which is related to the audio data.

A pop-up overlay may be displayed in response to the trigger event identified for the defined time in the audio data, as in block 550. The pop-up overlay may include a user interface control to capture a user action in response to the pop-up overlay being presented. In one example, the pop-up overlay may be a slide out user interface control that overlays the electronic page. In another example, the pop-up overlay may be a user interface control that overlays the electronic page and presents an action a user selects.

In one example, a user action may be received in the pop-up overlay. For example, the user action may involve a user clicking on an electronic link, answering a question, viewing a video, etc. Additional action material may be displayed in an electronic page browser in response to the user action.

In one example, the electronic page may include a progress play bar for the audio data that is shaped in a curvi-linear line and a graphical indicator displays progress in the playback of the audio data in the curvi-linear line. Alternatively, the electronic page may include a progress play bar for the audio data that is shaped in a sinusoidal path.

In one example, metric data may be collected representing a group of users and an amount of time the group of users listen to the audio data, a number of action overlays viewed, and whether users from the group of users generate trigger events. The metric data may be displayed on the electronic page.

In one example, user profile data that is known about a user may be obtained, and a pop-up overlay that is customized based on the user profile data may be presented. The user profile data may include information about the user, such as a user location, a user demographic, or a user interest.

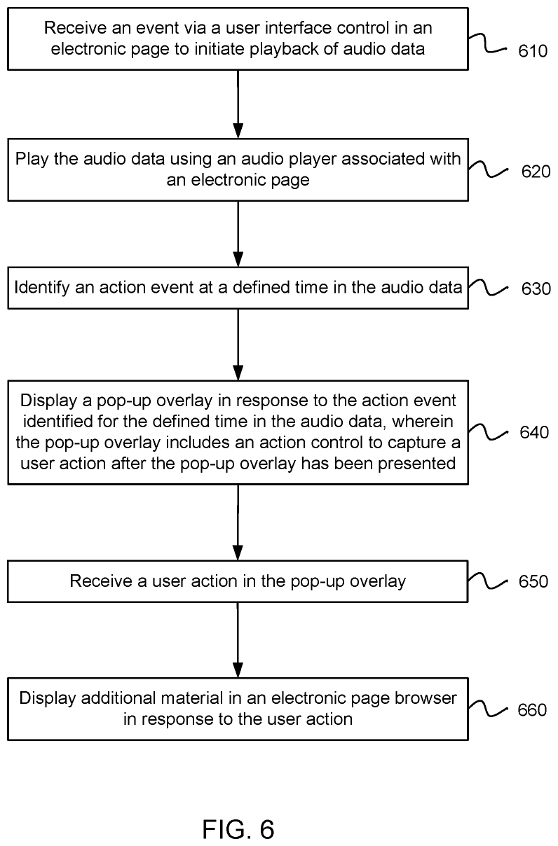

FIG. 6 illustrates an example of a method for engaging a user while accessing an electronic page. An event may be received via a user interface control in an electronic page to initiate playback of audio data, as in block 610.

The audio data may be played using an audio player associated with the electronic page, as in block 620. For example, a user may select a button or control on the audio player displayed on the electronic page to play the audio data.

A trigger event may be identified at a defined time in the audio data, as in block 630. As non-limiting examples, the trigger event at the defined time in the audio data may be associated with purchasing a product or service, obtaining a membership for a website, or providing additional information to a user which is related to the audio data.

A pop-up overlay may be displayed in response to the trigger event identified for the defined time in the audio data, as in block 640. The pop-up overlay may be a slide out modal popup that overlays the electronic page. The pop-up overlay may include an action control to capture a user action after the pop-up overlay has been presented. In addition, the pop-up overlay may include a user interface control to enable the trigger event, such as a purchase of a product or service or registering for a membership, and the trigger event may result in providing additional information to a user which is related to the audio data.

A user action may be received in the pop-up overlay, as in block 650. For example, the user action may involve a user clicking on an electronic link, answering a question, viewing a video, etc.

Additional material may be displayed in an electronic page browser in response to the user action, as in block 660. For example, the additional material displayed on the electronic page may be in response to the user clicking on an electronic link, answering a question, viewing a video, etc.

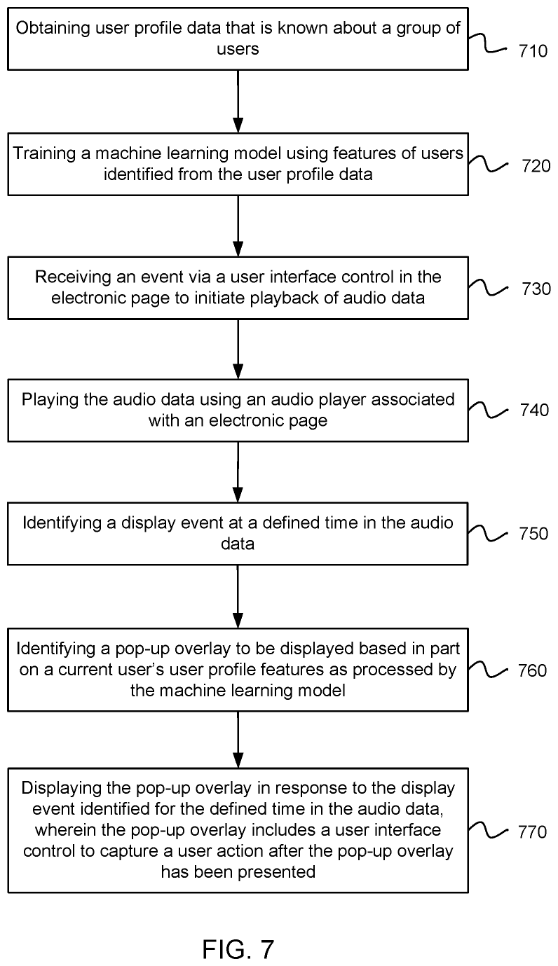

FIG. 7 illustrates an example of a method for engaging a user accessing an electronic page. User profile data that is known about a group of users may be obtained, as in block 710. The user profile data may include information about the users, such as a user location, a user demographic, or a user interest.

A machine learning model may be trained using features of users identified from the user profile data, as in block 720. For example, the machine learning model may be trained using features related to user locations, user demographics, user interests, etc. In another example, neural networks, supervised learning, or similar techniques may be used to develop a model that is trained using the features related to user locations, user demographics, user interests, etc.

An event may be received via a user interface control in the electronic page to initiate playback of audio data, as in block 730. For example, the event received via the user interface control may involve a user selecting an option on the user interface control to initiate playback of the audio data.

The audio data may be played using an audio player associated with an electronic page, as in block 740. For example, a user may select a button or control on the audio player displayed on the electronic page to play the audio data.

A display event at a defined time in the audio data may be identified, as in block 750. The display event at the defined time in the audio data may correspond to a predefined event that occurs in the audio data. As non-limiting examples, the display event at the defined time in the audio data may be associated with purchasing a product or service or obtaining a membership for a website, and the display event may result in providing additional information to a user which is related to the audio data.

A pop-up overlay to be displayed may be identified based in part on a current user's user profile features as processed by the machine learning model, as in block 760. For example, the pop-up overlay may be selected to include a combination of audio, video, electronic links, text, animation, etc. based on the current user's user profile features as processed by the machine learning model, and the pop-up overlay may be displayed on the electronic page.

The pop-up overlay may be displayed in response to the display event identified for the defined time in the audio data, as in block 770. The pop-up overlay may include a user interface control to capture a user action after the pop-up overlay has been presented.

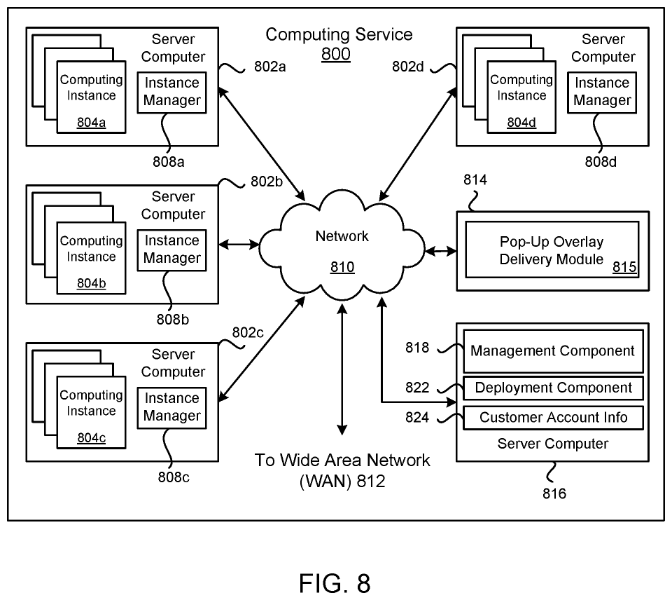

FIG. 8 is a block diagram illustrating an example computing service 800 or service provider environment that may be used to execute and manage a number of computing instances 804a-d upon which the present technology may execute. In particular, the computing service 800 depicted illustrates one environment in which the technology described herein may be used. The computing service 800 may be one type of environment that includes various virtualized service resources that may be used, for instance, to host computing instances 804a-d.

The computing service 800 may be capable of delivery of computing, storage and networking capacity as a software service to a community of end recipients. In one example, the computing service 800 may be established for an organization by or on behalf of the organization. That is, the computing service 800 may offer a “private cloud environment.” In another example, the computing service 800 may support a multi-tenant environment, wherein a plurality of customers may operate independently (i.e., a public cloud environment). Generally speaking, the computing service 800 may provide the following models: Infrastructure as a Service (“IaaS”), Platform as a Service (“PaaS”), and/or Software as a Service (“SaaS”). Other models may be provided. For the IaaS model, the computing service 800 may offer computers as physical or virtual machines and other resources. The virtual machines may be run as guests by a hypervisor, as described further below. The PaaS model delivers a computing platform that may include an operating system, programming language execution environment, database, and web server.

Application developers may develop and run their software solutions on the computing service platform without incurring the cost of buying and managing the underlying hardware and software. The SaaS model allows installation and operation of application software in the computing service 800. End customers may access the computing service 800 using networked client devices, such as desktop computers, laptops, tablets, smartphones, etc. running web browsers or other lightweight client applications, for example. Those familiar with the art will recognize that the computing service 800 may be described as a “cloud” environment.

The particularly illustrated computing service 800 may include a plurality of server computers 802a-d. The server computers 802a-d may also be known as physical hosts. While four server computers are shown, any number may be used, and large data centers may include thousands of server computers. The computing service 800 may provide computing resources for executing computing instances 804a-d. Computing instances 804a-d may, for example, be virtual machines. A virtual machine may be an instance of a software implementation of a machine (i.e. a computer) that executes applications like a physical machine. In the example of a virtual machine, each of the server computers 802a-d may be configured to execute an instance manager 808a-d capable of executing the instances. The instance manager 808a-d may be a hypervisor, virtual machine manager (VMM), or another type of program configured to enable the execution of multiple computing instances 804a-d on a single server. Additionally, each of the computing instances 804a-d may be configured to execute one or more applications.

A server 814 may be reserved to execute software components for implementing the present technology or managing the operation of the computing service 800 and the computing instances 804a-d. For example, the server 814 or computing instance may execute a pop-up overlay delivery service 815 operable to provide audio data for playback that is associated with an electronic page. The pop-up overlay delivery service 815 may determine that a defined time has been reached in the audio data. The pop-up overlay delivery service 815 may identify a trigger event associated with the defined time in the audio data. The pop-up overlay delivery service 815 may provide a pop-up overlay for display in response to the trigger event identified for the defined time in the audio data. The pop-up overlay may include a user interface control to capture a user action in response to the pop-up overlay being presented

A server computer 816 may execute a management component 818. A customer may access the management component 818 to configure various aspects of the operation of the computing instances 804a-d purchased by a customer. For example, the customer may setup computing instances 804a-d and make changes to the configuration of the computing instances 804a-d.

A deployment component 822 may be used to assist customers in the deployment of computing instances 804a-d. The deployment component 822 may have access to account information associated with the computing instances 804a-d, such as the name of an owner of the account, credit card information, country of the owner, etc. The deployment component 822 may receive a configuration from a customer that includes data describing how computing instances 804a-d may be configured. For example, the configuration may include an operating system, provide one or more applications to be installed in computing instances 804a-d, provide scripts and/or other types of code to be executed for configuring computing instances 804a-d, provide cache logic specifying how an application cache is to be prepared, and other types of information. The deployment component 822 may utilize the customer-provided configuration and cache logic to configure, prime, and launch computing instances 804a-d. The configuration, cache logic, and other information may be specified by a customer accessing the management component 818 or by providing this information directly to the deployment component 822.

Customer account information 824 may include any desired information associated with a customer of the multi-tenant environment. For example, the customer account information may include a unique identifier for a customer, a customer address, billing information, licensing information, customization parameters for launching instances, scheduling information, etc. As described above, the customer account information 824 may also include security information used in encryption of asynchronous responses to API requests. By “asynchronous” it is meant that the API response may be made at any time after the initial request and with a different network connection.

A network 810 may be utilized to interconnect the computing service 800 and the server computers 802a-d, 816. The network 810 may be a local area network (LAN) and may be connected to a Wide Area Network (WAN) 812 or the Internet, so that end customers may access the computing service 800. In addition, the network 810 may include a virtual network overlaid on the physical network to provide communications between the servers 802a-d. The network topology illustrated in FIG. 8 has been simplified, as many more networks and networking devices may be utilized to interconnect the various computing systems disclosed herein.

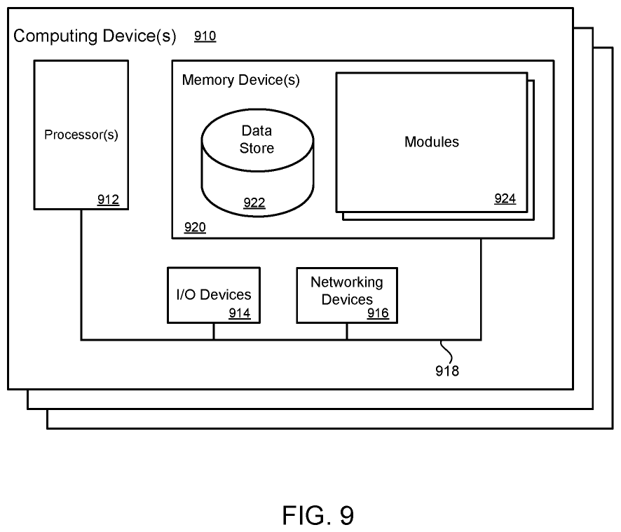

FIG. 9 illustrates a computing device 910 on which modules of this technology may execute. A computing device 910 is illustrated on which a high level example of the technology may be executed. The computing device 910 may include one or more processors 912 that are in communication with memory devices 920. The computing device may include a local communication interface 918 for the components in the computing device. For example, the local communication interface may be a local data bus and/or any related address or control busses as may be desired.

The memory device 920 may contain modules 924 that are executable by the processor(s) 912 and data for the modules 924. The modules 924 may execute the functions described earlier. A data store 922 may also be located in the memory device 920 for storing data related to the modules 924 and other applications along with an operating system that is executable by the processor(s) 912.

Other applications may also be stored in the memory device 920 and may be executable by the processor(s) 912. Components or modules discussed in this description that may be implemented in the form of software using high programming level languages that are compiled, interpreted or executed using a hybrid of the methods.

The computing device may also have access to I/O (input/output) devices 914 that are usable by the computing devices. An example of an I/O device is a display screen that is available to display output from the computing devices. Other known I/O device may be used with the computing device as desired. Networking devices 916 and similar communication devices may be included in the computing device. The networking devices 916 may be wired or wireless networking devices that connect to the internet, a LAN, WAN, or other computing network.

The components or modules that are shown as being stored in the memory device 920 may be executed by the processor 912. The term “executable” may mean a program file that is in a form that may be executed by a processor 912. For example, a program in a higher level language may be compiled into machine code in a format that may be loaded into a random access portion of the memory device 920 and executed by the processor 912, or source code may be loaded by another executable program and interpreted to generate instructions in a random access portion of the memory to be executed by a processor. The executable program may be stored in any portion or component of the memory device 920. For example, the memory device 920 may be random access memory (RAM), read only memory (ROM), flash memory, a solid state drive, memory card, a hard drive, optical disk, floppy disk, magnetic tape, or any other memory components.

The processor 912 may represent multiple processors and the memory 920 may represent multiple memory units that operate in parallel to the processing circuits. This may provide parallel processing channels for the processes and data in the system. The local interface 918 may be used as a network to facilitate communication between any of the multiple processors and multiple memories. The local interface 918 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method of engaging a user while accessing an electronic page, comprising:
identifying one or more defined times of potential interest in audio data using a machine learning model, where the one or more defined times corresponds to at least one of a specific word or phrase of interest, level of enthusiasm or intensity in tone;
presenting a listing of the one or more defined times of potential interest via a developer interface;
receiving a selection of a defined time from the listing of the one or more defined times of potential interest;
receiving an event via a user interface control in the electronic page to initiate playback of the audio data;
playing the audio data using an audio player associated with the electronic page as initiated by the event;
determining that the defined time has been reached in the audio data;
identifying a trigger event associated with the defined time in the audio data; and
displaying a pop-up overlay in response to the trigger event identified for the defined time in the audio data, wherein the pop-up overlay includes an additional user interface control to capture a user action in response to the pop-up overlay being presented.

2. The method of claim 1, further comprising:
receiving a user action in the pop-up overlay; and
displaying additional action material in an electronic page browser in response to the user action.

3. The method of claim 1, wherein the pop-up overlay is a slide out user interface control that overlays the electronic page.

4. The method of claim 1, wherein the pop-up overlay is a user interface control that overlays the electronic page and presents an action a user selects.

5. The method of claim 1, wherein the trigger event is a purchase of a product or service.

6. The method of claim 1, wherein the trigger event is obtaining a membership for a website.

7. The method of claim 1, wherein the trigger event results in providing additional information to a user which is related to the audio data.

8. The method of claim 1, further comprising a progress play bar for the audio data that is shaped in a curvi-linear line and a graphical indicator displays progress in playback of the audio data in the curvi-linear line.

9. The method of claim 1, wherein metric data is collected representing a group of users and an amount of time the group of users listen to the audio data, and whether users from the group of users engage with the pop-up overlay.

10. The method of claim 1, wherein the electronic page is contained in a browser or an application.

11. The method of claim 1, further comprising:
obtaining user profile data that is known about a user; and
presenting the pop-up overlay that is customized based on the user profile data.

12. The method of claim 11, wherein the user profile data contains information about a user that includes at least one of: a user location, a user demographic, or a user interest.

13. A non-transitory machine readable storage medium including instructions embodied thereon, the instructions when executed by one or more processors:
identify one or more defined times of potential interest in audio data using a machine learning model, where the one or more defined times corresponds to at least one of a specific word or phrase of interest, level of enthusiasm or intensity in tone;
present a listing of the one or more defined times of potential interest via a developer interface;
receive a selection of a defined time from the listing of the one or more defined times of potential interest;
receive an event via a user interface control in an electronic page to initiate playback of the audio data;
play the audio data using an audio player associated with the electronic page;
identify a trigger event at the defined time in the audio data;
display a pop-up overlay in response to the trigger event identified for the defined time in the audio data, wherein the pop-up overlay includes an action control to capture a user action after the pop-up overlay has been presented;
receive a user action in the pop-up overlay; and
display additional material in an electronic page browser in response to the user action.

14. The non-transitory machine readable storage medium of claim 13, wherein the pop-up overlay is a slide out modal popup that overlays the electronic page.

15. The non-transitory machine readable storage medium of claim 13, wherein the pop-up overlay includes a user interface control to enable a trigger event that is at least one of: a purchase of a product or service, registering for a membership, or providing additional information.

16. The non-transitory machine readable storage medium of claim 13, further comprising a progress play bar for the audio data that is shaped in a sinusoidal path.

17. The non-transitory machine readable storage medium of claim 13, wherein metric data is collected representing a group of users and an amount of time the group of users listen to the audio data, a number of action overlays viewed, and trigger events generated.

18. The non-transitory machine readable storage medium of claim 13, further comprising:
obtaining user profile data that is known about a user; and
presenting an action overlay that is customized based on the user profile data.

19. A method for engaging a user accessing an electronic page, comprising:
obtaining user profile data that is known about a group of users;
training a machine learning model using features of users identified from the user profile data;
identifying one or more defined times of potential interest in audio data using the machine learning model, where the one or more defined times corresponds to at least one of a specific word or phrase of interest, level of enthusiasm or intensity in tone;
presenting a listing of the one or more defined times of potential interest via a developer interface;
receiving a selection of a defined time from the listing of the one or more defined times of potential interest;
receiving an event via a user interface control in the electronic page to initiate playback of the audio data;
playing the audio data using an audio player associated with the electronic page;
identifying a display event at the defined time in the audio data;
identifying a pop-up overlay to be displayed based in part on a current user's user profile features as processed by the machine learning model; and
displaying the pop-up overlay in response to the display event identified for the defined time in the audio data, wherein the pop-up overlay includes an additional user interface control to capture a user action after the pop-up overlay has been presented.

20. The method as in claim 19, further comprising:
receiving a user action in the pop-up overlay; and
displaying additional material in an electronic page browser in response to the user action.
